(19) United States
(12) Patent Application Publication
(10) Pub. No.: US 2024/0217608 A1
(43) Pub. Date: Jul. 4, 2024

(54) BICYCLE WITH MOVING AND/OR MORPHING AERODYNAMIC FRAME ELEMENTS

(71) Applicant: 2592497 Ontario Inc., Toronto (CA)

(72) Inventors: Nicole VAN BEURDEN, Toronto (CA); Philip WHITE, Toronto (CA)

(21) Appl. No.: 18/288,895

(22) PCT Filed: Apr. 28, 2022
(86) PCT No.: PCT/CA2022/050651

§ 371 Date: Oct. 30, 2023

Related U.S. Application Data
(60) Provisional application No. 63/182,182, filed on Apr. 30, 2021.

(51) Int. Cl. B62J 17/00; B62J 1/08; B62K 3/02; B62K 21/12

(52) U.S. Cl. CPC B62J 17/00; B62K 3/02; B62K 21/125; B62J 1/08

(57) ABSTRACT

Described herein are frame elements for bicycles, and bicycles comprising such frame elements, which are moveable and/or morphable. The frame elements may be moveable and/or morphable in response to an external force, such as an aerodynamic wind load, or a control mechanism operatively connected thereto. Examples of the moveable and/or morphable frame elements include a front fork or one or more sections of the front fork, a seat tube or one or more sections of the seat tube, a cockpit or one or more sections of the cockpit, handlebars or one or more sections of the handlebars, a seat tube or one or more sections of the seat tube, a seat post or one or more sections of the seat post, a top tube or one or more sections of the top tube, and a head tube or one or more sections of the head tube.

### CROSS-REFERENCE TO RELATED APPLICATIONS

The present application claims priority from U.S. Provisional Patent Application No. 63/182,182 filed on Apr. 30, 2021, the contents being incorporated herein by reference.

### FIELD

The present disclosure relates generally to an aerodynamic bicycle constructed with moveable and/or morphing frame components and materials that are configured to adapt in shape and/or orientation to respond to changes in environmental conditions, such as atmospheric wind conditions.

### BACKGROUND

Several different forces oppose the movement of a bicycle when in use. A significant force acting against the movement of a bicycle is the drag induced by the bicycle's movement through the air (also known as “form drag”). Another significant force acting against the movement of a bicycle is the drag created by the atmospheric wind. When cycling outside, the atmospheric wind angle may be between 0 degrees and 360 degrees, relative to the cyclist's direction of movement. As cyclists are generally riding on roads or other terrain, they cannot always easily adapt their direction of travel so as to minimize the effects of drag from wind. The cyclists and their bicycles must therefore overcome the wind forces and directions with which they are faced, as the wind conditions cannot be changed.

Because a cyclist is moving forward at a particular velocity the effective wind angle (or yaw angle) that the cyclist and the bicycle experiences is the vector sum of the bicycle velocity and the wind velocity. Wind gusts may actually result in significantly higher instantaneous yaw angles than the average and may result in buffeting and instability. Such buffeting and instability may distract cyclists from performing at their highest levels and also requires cyclists to expend additional force and energy to overcome the buffeting and instability, when such effort would otherwise be expended in propelling the bicycle forward at a greater velocity.

These aerodynamic drag forces are particularly problematic for athletic and professional cyclists. The power required to overcome this drag force is proportional to the velocity of the vehicle raised to the third power. Greater speed results in greater drag which in turn requires the cyclist to expend greater energy to overcome the drag and this detrimentally affects a cyclist's performance. Accordingly, reducing the drag forces is an important consideration for racing cyclists and for other serious cyclists.

It is generally known that many bicycles are commonly comprised of a bicycle frame, a front fork, front and rear wheels, a seat post, a seat and a cockpit, which may be comprised of a stem and handlebars. While the geometric design of the bicycle frame may be varied, it is known that many bicycle frames are commonly comprised of two open triangles adjoining along a common side. The respective size and orientation of two triangles which make up the bicycle frame may be varied. However, there is commonly a front triangle comprised of tubular or other generally elongate frame elements which often include a seat tube, a top tube, a down tube and a head tube. There is also commonly a rear triangle comprised of tubular elements which often include two seat stays, which couple to the seat tube and two chain stays, which couple to the seat tube. The seat tube is the common side shared between the two open triangles. The tubular elements may be comprised of various rigid materials and fixed shapes, which are joined in a fixed orientation relative to one another through different techniques known in the art, depending on the material.

In certain known embodiments, the geometric arrangement of the bicycle frame has been varied. For example, U.S. Patent Publication No. US2010/0289246A1 discloses a bicycle with a bicycle frame which does not rely on the traditional arrangement of two open triangles adjoining along a common side. Instead, the tubular elements comprising the bicycle frame meet at angular joints, rather than connecting along a common side.

Bicycles and particularly bicycle frames have developed over the last 40 or so years to become more aerodynamic. Various manufacturers have attempted to reduce the impact of the wind forces described above on cyclists and their bicycles. This has traditionally been achieved by modifying the structural shape of the tubes which commonly comprise the tubular elements of a bicycle frame and other parts of the bicycle, such as the cockpit or seat post, to create tubing that is shaped more like an airfoil or teardrop and can be used in bicycle frames to minimize the drag forces on the tubular elements and bicycle frame itself. The camber or curvature of the tubes is generally increased to achieve this effect. Generally speaking, the tubular elements of such bicycles are immovable or otherwise fixed in shape.

For example, U.S. Pat. No. 7,931,289 B2 discloses an airfoil shape which may be used for a bicycle, in the tubular elements comprising the bicycle frame or other components on the bicycle. The air foil shape described is a tear-drop shape, similar to an airplane wing, with a round front and pointed rear. This shape is intended to promote laminar airflow and reduce drag.

Other manufacturers have tried to reduce the negative impact of wind forces on the bicycle frame by adding texture to the tubular elements comprising the bicycle frame. For example, U.S. Pat. No. 9,963,187 B1 discloses an aerodynamic bicycle frame where the airfoil tubes comprising the frame include depressions and scoops on the surface of the tubular elements of the aerodynamic bicycle frame. Such depressions and scoops are intended to decrease the drag exerted on the bicycle frame but cannot adapt to the different wind forces and angles experienced by a cyclist. Again, the tubular elements are immovable or otherwise fixed in shape.

In the U.S. patents described above, the airfoils used in the bicycle frame have had zero camber. That is, the tubes used in the tubular elements are symmetric on both sides of the longitudinal center line of the bicycle.

Various manufacturers have attempted to further address the limitations of the bicycle frames described above, by adjusting the camber of the bicycle frame tubing to create a shape which is optimized to a certain direction of wind force, as experienced by cyclists and their bike frames when riding on indoor velodromes. This illustrates the need to adjust the shape of the bicycle frame tubing depending on the wind angle, effectively altering the angle at which the wind forces meet the tubular elements of the bicycle frame to reduce the drag effects of the wind on the bicycle. For example, U.S. Patent Publication No. US2017/0334510A1 discloses a bicycle with a bicycle frame comprised of tubing which is cambered. The left side of the tubular elements are closer to the central plane of the bicycle frame than the right side of the tubular elements. The tubular elements are immovable or otherwise fixed in shape.

All of these designs, however, are designed to be most advantageous when the bicycle is experiencing a specific yaw angle. Most of these designs are optimized for a 0-degree yaw angle, where the air forces are directly opposing the direction that the bicycle is travelling, while the disclosure of U.S. Patent Publication No. US 2017/0334510 A1 is optimized for a single, non-zero yaw angle, which is known in indoor settings such as a velodrome. However, cyclists are unable to control the direction of the wind relative to their direction of travel when outdoors, or in indoor settings that have bends or turns of varying degrees and directions, and so many wind angles will be experienced while riding a bicycle in such conditions.

The performance of these existing designs is decreased when the yaw angle of the wind increases and the direction the bicycle is traveling in is not directly opposite the air forces on the bicycle. This is known as a cross-wind. When airfoil tubes are used to construct a bicycle frame, if the cyclist is riding in a direction with wind forces at greater than 0-degree yaw angle, the greater lateral surface area of the airfoil tubes leads to higher side forces on the bicycle frame. These lateral forces, exerted by the wind on the bicycle frame, lead to the cyclist experiencing instability. Cyclists then expend excess energy trying to stabilize their bicycles and maintain control of the bicycle.

As the shape and orientation of the tubular elements comprising the bicycle frame are fixed, the degree to which the bicycle frame can be optimized for any wind condition and wind angle is restricted. While the impact of the wind forces under certain conditions is minimized, the wind remains a force which inhibits the cyclist's ability to move their bicycle in a forward direction.

Accordingly, a bicycle is needed to address the shortfalls of the present technology and to provide other new and innovative features.

### SUMMARY OF THE INVENTION

According to some embodiments, the present disclosure describes a bicycle comprising one or more frame elements which are moveable and/or morphable in whole or in part. The frame elements may, for example, comprise tubular or generally elongate frame elements.

According to some embodiments, the frame elements which are moveable and/or morphable comprise one or more of: a front fork or one or more sections of the front fork; a seat tube or one or more sections of the seat tube; a cockpit or one or more sections of the cockpit; a stem or one or more sections of the stem; handlebars or one or more sections of the handlebars; a seat tube or one or more sections of the seat tube; a seat post or one or more sections of the seat post; a top tube or one or more sections of the top tube; a down tube or one or more sections of the down tube; a head tube or one or more sections of the head tube; a seat stay or one or more sections of the seat stay; and a chain stay or one or more sections of the chain stay.

According to some embodiments, the moveable and/or morphable frame elements are moveable by actuation of an actuating mechanism.

According to some embodiments, the moveable and/or morphable frame elements move passively when subject to an external force.

According to some embodiments, the external force comprises a lateral force.

According to some embodiments, the lateral force comprises a force from a cross wind.

According to some embodiments, the one or more frame elements comprise one or more moveable and/or morphable frame elements or sections and one or more immovable and/or morphable frame elements or sections, wherein the moveable and/or morphable tubular elements or sections are coupled to the immovable or non-morphable (fixed in shape) frame elements or sections.

According to some embodiments, the moveable and/or morphable frame elements are pivotably or hingedly coupled to the immovable or non-morphable tubular elements or sections.

According to some embodiments, the moveable or non-morphable frame elements or sections comprise a flexible and/or a deformable material.

According to some embodiments, the moveable and/or morphable frame elements or sections move by flexing and/or deforming when subjected to an external force.

### BRIEF DESCRIPTIONS OF THE DRAWINGS

For a better understanding of the various non-limiting example implementations described herein, and to show more clearly how they may be carried into effect, reference will now be made, by way of example only, to the accompanying drawings in which:

FIGS. 1A and 1B depict a diagrammatic representation of two different airfoil sections.

FIG. 1A depicts the section view of a cambered airfoil and FIG. 1B depicts the section view of a symmetric uncambered airfoil;

FIG. 2 depicts a lateral view of a sailboat with a hard sail;

FIG. 3 depicts a cross-sectional view through the hard sail depicted in FIG. 2;

FIG. 4 depicts a multi-element wing as typically used on aircraft to achieve the high camber (and associated high lift) as depicted in FIG. 1A;

FIG. 5 depicts a diagrammatic representation of a bicycle and the various subcomponents of a bicycle, according to non-limiting embodiments;

FIG. 6 depicts a diagrammatic representation of a bicycle frame, according to non-limiting embodiments;

FIG. 7 depicts a diagrammatic representation of a sideview of a bicycle frame with a moveable down tube, according to non-limiting embodiments;

FIG. 8 depicts a diagrammatic representation of a sideview of a bicycle frame with a seat tube, where the leading section of said seat tube is movable, capable of changing orientation, and the trailing section of said seat tube is immovable or not morphable, according to non-limiting embodiments;

FIG. 9 depicts a diagrammatic representation of a sideview of a bicycle frame with a head tube, where the trailing section of said head tube is movable (e.g., capable of changing orientation) and/or morphable, and the leading section of said head tube is immovable, according to non-limiting embodiments;

FIG. 10 depicts a diagrammatic representation of the front-end of a bicycle where certain parts of the cockpit and front fork are moveable and/or morphable, according to non-limiting embodiments;

FIG. 11 depicts a diagrammatic representation of a bicycle frame where the seat post is capable of movement, according to non-limiting embodiments;

FIG. 12 depicts a diagrammatic representation of a bicycle frame where the seat post, integrated into the seat tube, is capable of movement, according to non-limiting embodiments;

FIG. 13 depicts a sideview of a bicycle frame with a moveable and/or morphable seat tube, according to non-limiting embodiments;

FIG. 14 depicts a sideview of a bicycle frame in partial cross-section to show a pivot mechanism of a moveable seat tube, according to non-limiting embodiments;

FIG. 15 depicts a diagrammatic representation of a bicycle frame with a seat tube, where a portion of the seat tube is moveable and/or morphable and comprised of a flexible material, and as detailed in Section B-B is capable of deviating from a neutral position, according to non-limiting embodiments;

FIG. 16 depicts a diagrammatic representation of a side view of a bicycle frame with a seat tube where only the trailing section of said seat tube is moveable, according to non-limiting embodiments;

FIG. 17 depicts a diagrammatic representation of a side view of a bicycle frame, where a trailing section of the seat tube is moveable and/or morphable and comprised of flexible material and a leading section of the seat tube is moveable through a pivot mechanism, according to non-limiting embodiments;

FIG. 18 depicts a diagrammatic representation of a side view of a bicycle frame with a seat tube comprised of independently moveable sections. Section A-A depicts the relative positions of the independently moveable and/or morphable sections of the seat tube, in the neutral position and with the elements deflected, according to non-limiting embodiments; and

FIGS. 19A and 19B depict diagrammatic representations of a transverse view of a frame element with a leading moveable section and trailing immoveable section, according to non-limiting embodiments.

### DETAILED DESCRIPTION

It has long been recognized that the aerodynamic performance, including the lift, drag, and stall angle of aerodynamic elements can be improved by modifying the shape to increase the camber or curvature of the aerodynamic element.

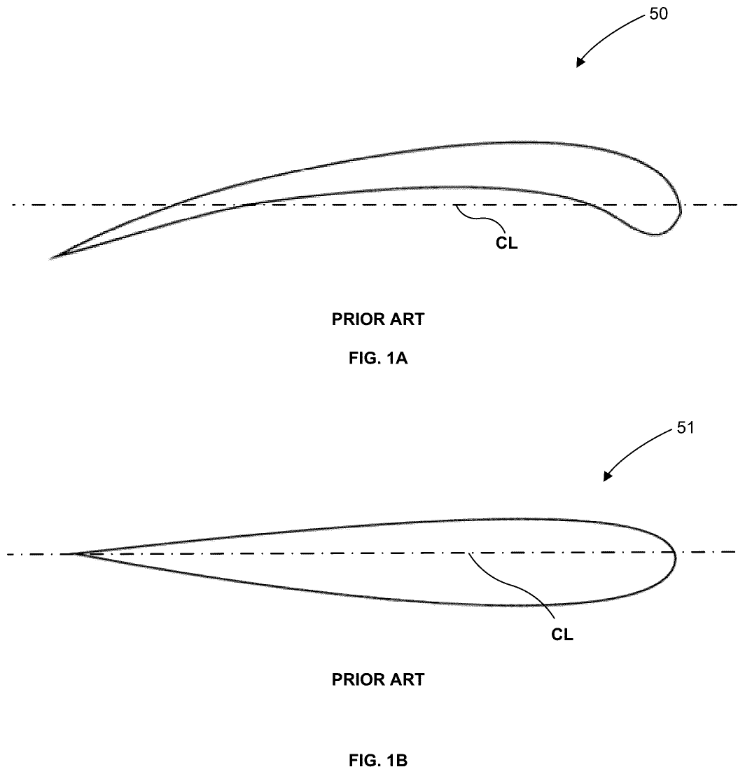

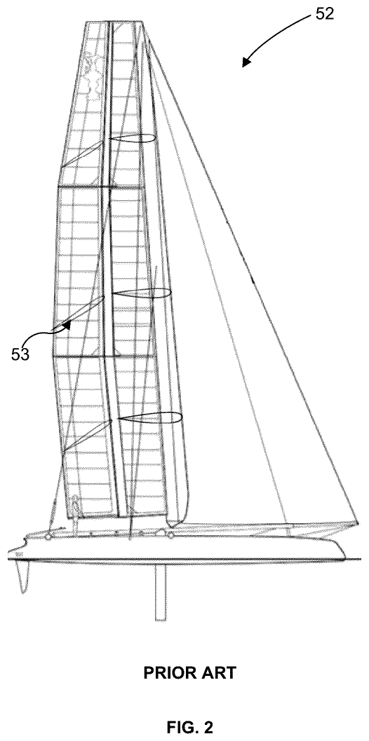

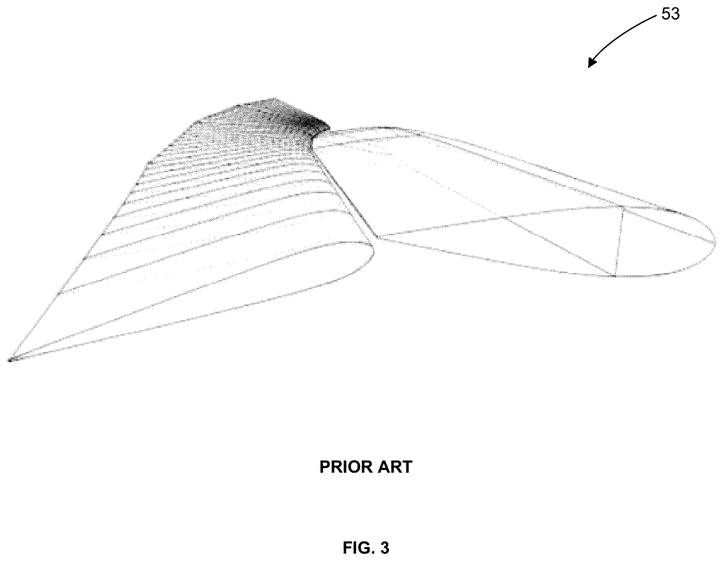

Attention is directed to FIGS. 1A and 1B which depict the airfoils commonly used to comprise different elements of a bicycle, such as the tubes of a bicycle frame. FIG. 1A depicts a cambered airfoil 50, where the shape of the airfoil is not symmetrical about the centerline. FIG. 1B depicts a non-cambered airfoil 51, where the shape of the airfoil is symmetrical about the centerline CL. Aerodynamic performance can be improved by increasing the camber or curvature of the aerodynamic element as shown in the transition from FIG. 1B to FIG. 1A. Both forms of airfoils have previously been used in structural aspects of a bicycle or bicycle frame. However, the airfoil shape used in bicycles and bicycle frames has always been formed into the airfoil element and the shape fixed and immoveable. FIG. 2 depicts a lateral view of a sailboat 52 with a hard sail 53. FIG. 3 depicts a cross-sectional view through the hard sail depicted in FIG. 2.

Attention is directed to FIGS. 2 and 3, which depicts a multi-element wing as typically used on aircraft to achieve the high camber (and associated high lift) as depicted in FIG. 1A. and illustrates how this same principle has also been explored for sailing vessels in the wing sail boats of the C-Class catamaran and Americas Cup AC72, AC45, and AC62 amongst others which use a composite tandem airfoil, as depicted in FIG. 3.

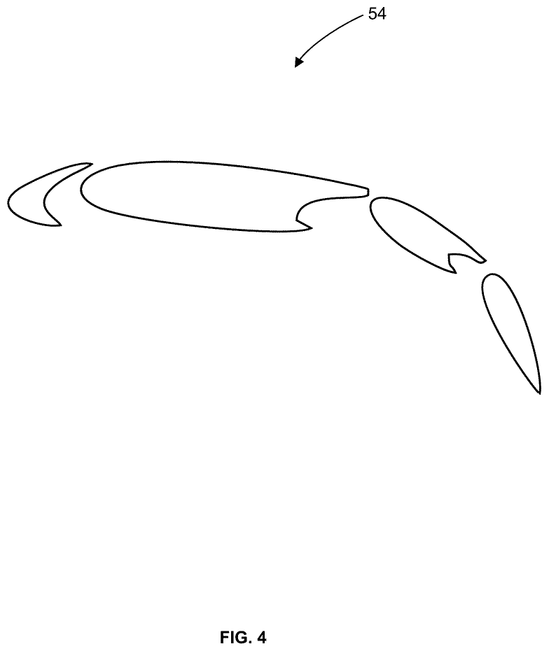

Attention is directed to FIG. 4 which illustrates an example of how this principle has been exploited in aircraft design through wing trailing edge flaps and wing leading edge extensions.

The symmetrical and immovable airfoils previously used for bicycles are ideal in 0-degree yaw. However, to maintain minimal drag, the camber of the airfoil must increase as the yaw angle increases. When a cyclist and the cyclist's bicycle are travelling through wind forces at an angle greater than 0-degree yaw, known as a cross-wind, ideally the camber of the airfoils included in the bicycle would change and adapt to the wind forces. The surfaces comprising the airfoil would ideally be passive and react to the ambient wind conditions or be actively controlled to respond to the ambient wind conditions. The resulting cambering of an airfoil is important for both increasing lift and decreasing drag as yaw angles increase. This has not been possible in previous bicycle designs where the airfoil components which comprise a bicycle and particularly bicycle frames have been fixed immovable shapes.

There are potential advantages in bicycle performance if the aerodynamic shape of the frame elements comprising the bicycle could move and therefore adapt to the prevailing wind conditions by changing their shape.

Prior to the present application, conventional thinking would have led skilled persons away from including moveable and/or morphing frame elements in bicycles, as disclosed herein, for at least the following reasons:
a. The frame elements comprising a bicycle have always been considered a fixed structural aspect of the bicycle. As a result, the frame elements have progressively evolved into more aerodynamic (e.g., less circular/cylindrical) but fixed, immoveable structural shapes.
b. Previously, the structural loads and aerodynamic loads experienced by a bicycle have not been considered separately, and so the ability to separate the structural aspects of the bicycle from the aerodynamic design elements has not previously been considered.
c. Wind tunnel and aerodynamic testing has been used to determine a way to decrease the impact of the wind and corresponding drag forces as much as possible. Conventional thinking has not considered how to harness the wind forces or use the wind forces experienced by a bicycle to benefit cyclist and positively increase the cyclist's forward momentum.

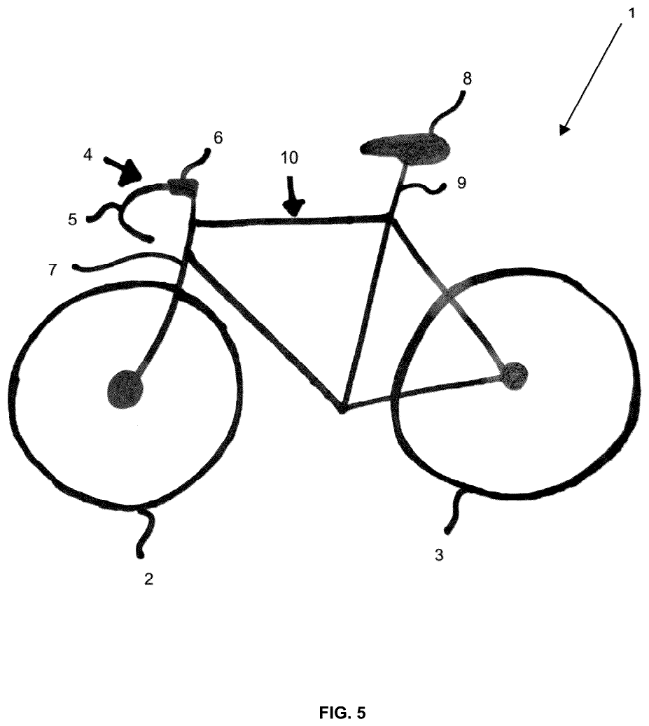

Attention is now directed to FIG. 5, which depicts a non-limiting embodiment of a bicycle 1. According to non-limiting embodiments, bicycle 1 may include front wheel 2, rear wheel 3, cockpit 4 comprised of handlebars 5 and stem 6, front fork 7, seat 8, seat post 9 and bicycle frame 10, each depicted according to non-limiting embodiments. Notably, in many cases the elements of a bicycle are single and/or compound shapes that are multi-functional and perform structural, aerodynamic and/or other functions.

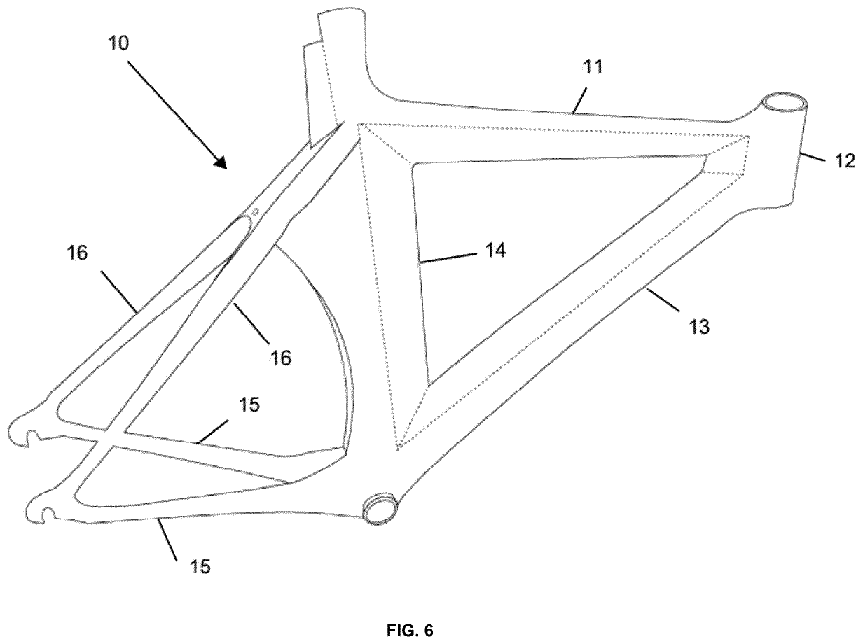

Attention is now directed to FIG. 6 which depicts a non-limiting embodiment of a bicycle frame 10. According to non-limiting embodiments, bicycle frame 10 may be comprised of the following frame elements: top tube 11, head tube 12, down tube 13, seat tube 14, chain stays 15, and seat stays 16, each depicted according to non-limiting embodiments. The shape of the frame elements may be varied. According to some embodiments, the frame elements may be at least partially tubular and/or generally elongate in shape. For example, the frame elements may be cylindrical in cross-section, but also may be formed in a more aerodynamic shape such as an elliptical cross-section. The cross-sectional shape of the frame elements may be symmetrical or asymmetrical. The frame elements may be hollow and/or partially or completely solid. According to some embodiments, the frame elements may be at least partially filled or comprise a bulkhead. Similarly, the material comprising the frame elements may be varied. For example, the frame elements may be comprised of aluminum, carbon fiber, titanium, steel or other materials known in the art. According to some embodiments, the frame elements are comprised of, at least in part, composite materials, such as fiberglass, graphite, boron, Kevlar™, graphite, ceramic fibers or any suitable combination thereof. The means by which the different frame elements are coupled may also be varied, depending on the material used to comprise the tubular elements.

According to non-limiting embodiments, various frame elements of the bicycle 1 may be capable of movement, relative to other elements of bicycle 1. Further, only one frame element of bicycle 1 may be capable of movement or multiple frame elements of bicycle 1 may be capable of movement. The moveable frame elements may be moved intentionally through a control mechanism and/or moved passively, through adaptation by the frame elements when subjected to external forces, such as a lateral force (e.g., a lateral cross-wind). The “moveable” nature of moveable frame elements is assessed with regards to one frame element's ability to change position or shape (morph), in whole or in part, relative to other frame elements.

According to non-limiting embodiments, the moveable and immoveable frame elements may be comprised of the same or similar materials which includes aluminum, carbon, steel, titanium and other materials know in the art. Alternatively, according to non-limiting embodiments, the moveable and immoveable frame elements may be comprised of different materials. According to non-limiting embodiments, the moveable frame elements may be comprised of flexible or deformable material, which is not structurally rigid or fixed, as understood in the art, but capable of movement to change position and/or shape in response to the actuation of a control mechanism and/or in response to an external force (such as an aerodynamic load). According to non-limiting embodiments, the moveable frame elements are designed to adapt or change position or shape to help gain aerodynamic advantage and/or increase the cyclist's stability on bicycle 1. According to non-limiting embodiments, the moveable and immoveable frame elements may be hingedly or pivotably coupled to each other by commonly known coupling means such as hinge joints, pivot joints, expansion joints, flexible joints, condyloid joints, gliding joints, sliding joints, floating joints and other means known in the art, or any combination thereof.

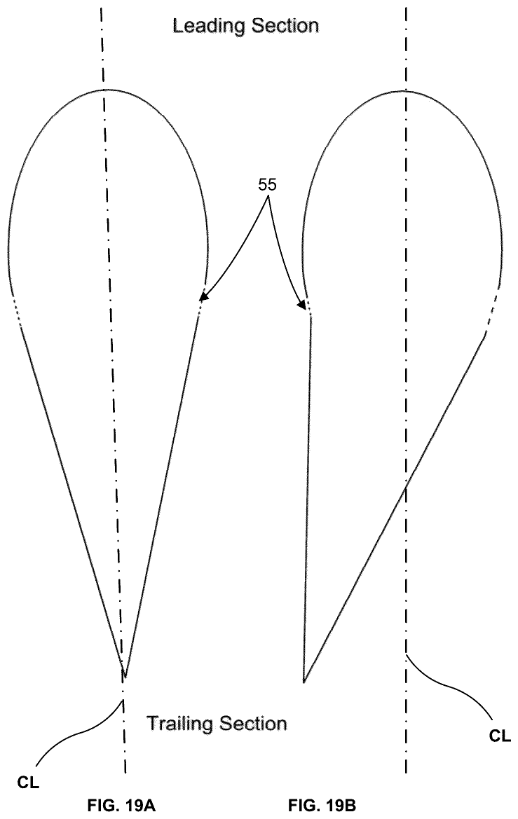

Attention is now directed to FIGS. 19A and 19B, which depict a frame element with moveable and immoveable sections, according to non-limiting elements. FIGS. 19A and 19B depict the transverse view of a frame element where the leading section of the tubular element is immoveable and the trailing section of the frame element is moveable, according to non-limiting embodiments. In FIGS. 19A and 19B, the dotted line 55 depicts the coupling between the immoveable leading section of the frame element and the moveable trailing section of the frame element, according to non-limiting embodiments. FIG. 19A depicts the moveable section of the frame element in a neutral position, according to non-limiting embodiments. FIG. 19B depicts the movement of the trailing section of the frame element in comparison to the immoveable section of the frame element, as depicted by the relative leftward movement of the moveable trailing section between FIG. 19A and FIG. 19B, according to non-limiting embodiments.

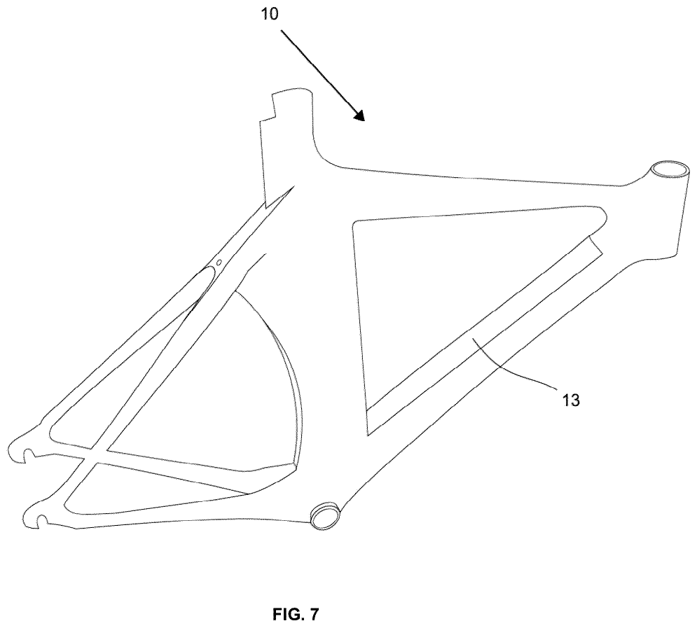

Attention is now directed to FIG. 7, which depicts a bicycle frame 10 according to a non-limiting embodiment, where the down tube 13 is the at least one frame element of bicycle frame 10 which is capable of movement, relative to other elements of bicycle frame 10, either when intentionally moved (e.g., through actuation of a control mechanism or device) or through adaptation to an external force, such as a lateral force (e.g., a lateral cross-wind).

According to some embodiments, all sections of a moveable frame element (which may be comprised of one or multiple sections) may be capable of movement, while according to other embodiments, only certain sections of a moveable frame element of the bicycle 1 may be capable of movement. When referring to the “leading section,” reference is made to the portion of the frame element which is proximal to the typical forward or fore direction of travel of a bicycle 1. When referring to the “trailing section,” reference is made to the portion of the frame element which is distal or aft to the typical forward direction of travel of bicycle 1.

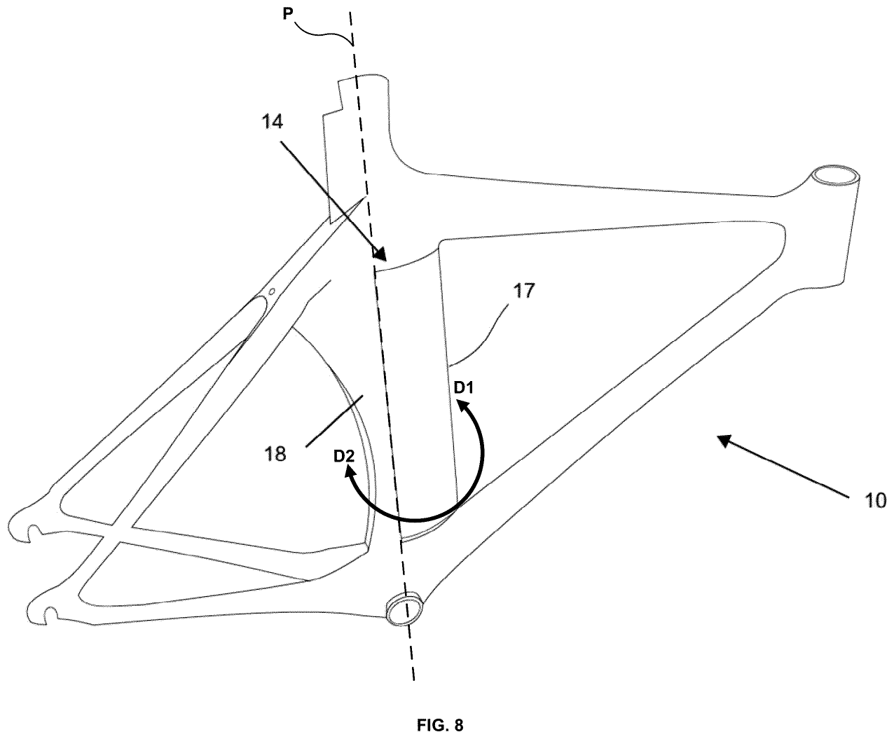

Attention is now directed to FIG. 8, which depicts a bicycle frame 10 according to a further non-limiting embodiment, where only the leading section 17 of seat tube 14 is capable of movement and/or morphable in shape, and the trailing section 18 of seat tube 14 is not moveable (fixed in position and shape). For example, according to some embodiments, leading section 17 is pivotably coupled to trailing section 18 and enabled to pivot about pivot axis P in the direction of D1 and/or D2 (FIG. 8). According to some embodiments, leading section 17 is deformable or otherwise alterable in shape.

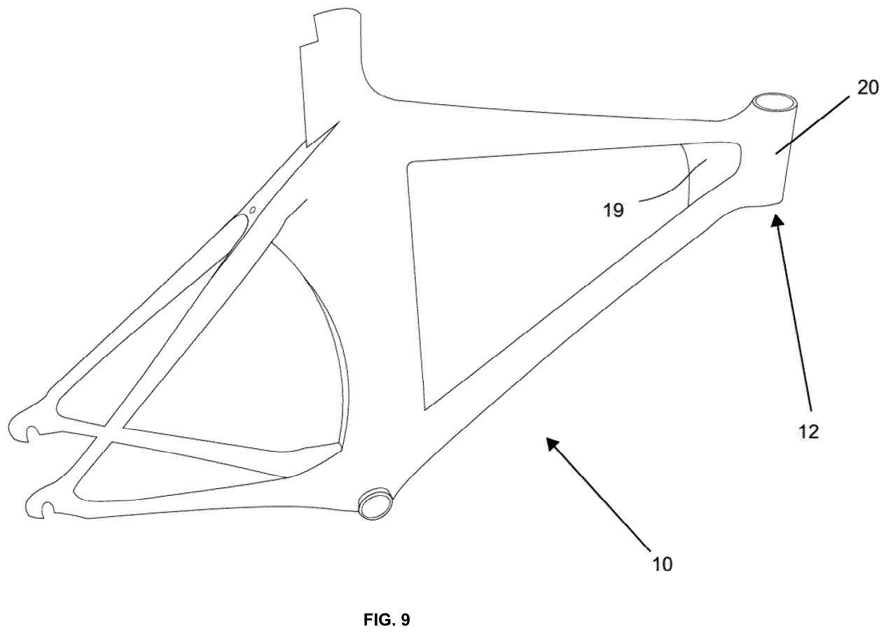

Attention is now directed to FIG. 9, which depicts a bicycle frame 10 according to a further non-limiting embodiment, where the trailing section 19 of head tube 12 is moveable and/or morphable, and the leading section 20 of head tube 12 is immoveable (fixed in position and shape). According to some embodiments, trailing section 19 is moveable and/or morphable in shape in manner similar to leading section 17 as described above.

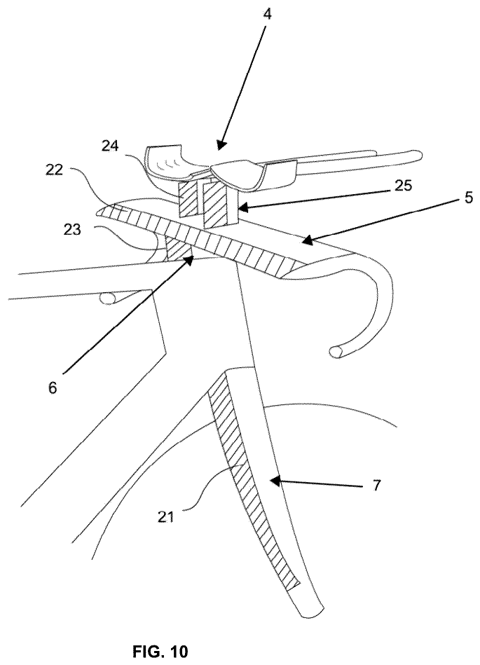

Attention is now directed to FIG. 10, which depicts a portion of a bicycle 1 according to a further non-limiting embodiment, where the trailing sections (depicted by shaded etching) of the frame elements of cockpit 4 and fork 7 are capable of movement. For example, trailing section 21 of fork 7, trailing section 22 of handlebar 5, trailing section 23 of stem 6, and/or trailing section 24 of aerobar risers 25 are capable of movement. For example, one or more of trailing sections 21, 22, 23 and 24 may be moveable and/or morphable in shape in manner similar to leading section 17 as described above.

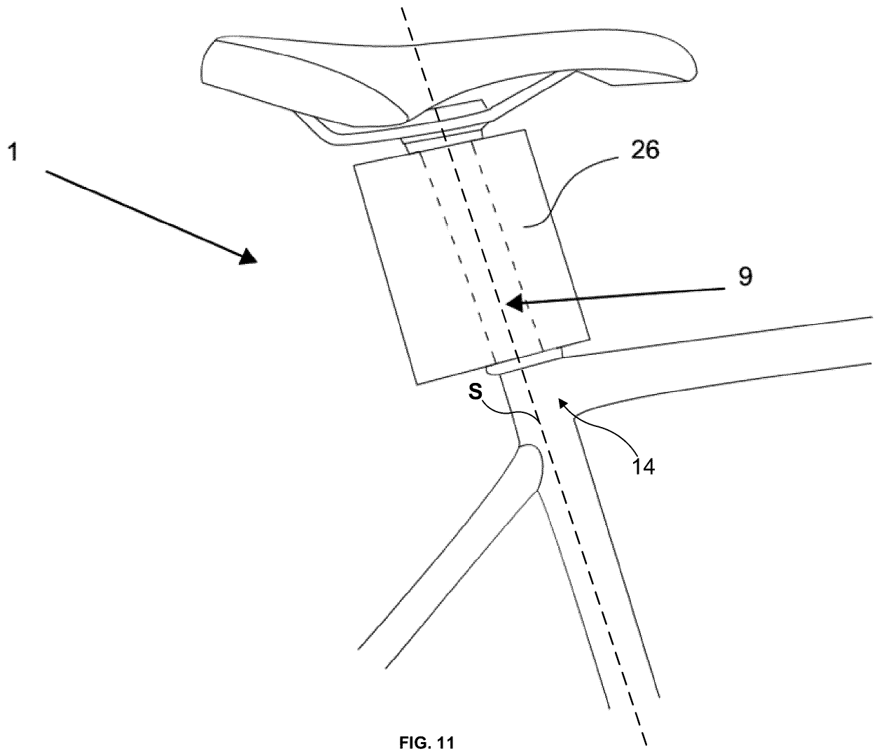

In some embodiments, further elements may be added to or disposed over or about certain frame elements or sections of the bicycle 1. For example, FIG. 11 depicts frame element 26 which may be disposed over or about seat post 9, such that element 26 may rotate about its longitudinal axis through which seat post 9 passes (such as axis S), according to non-limiting embodiments. According to some embodiments, element 26 may comprise an airfoil or other aerodynamically advantageous shape.

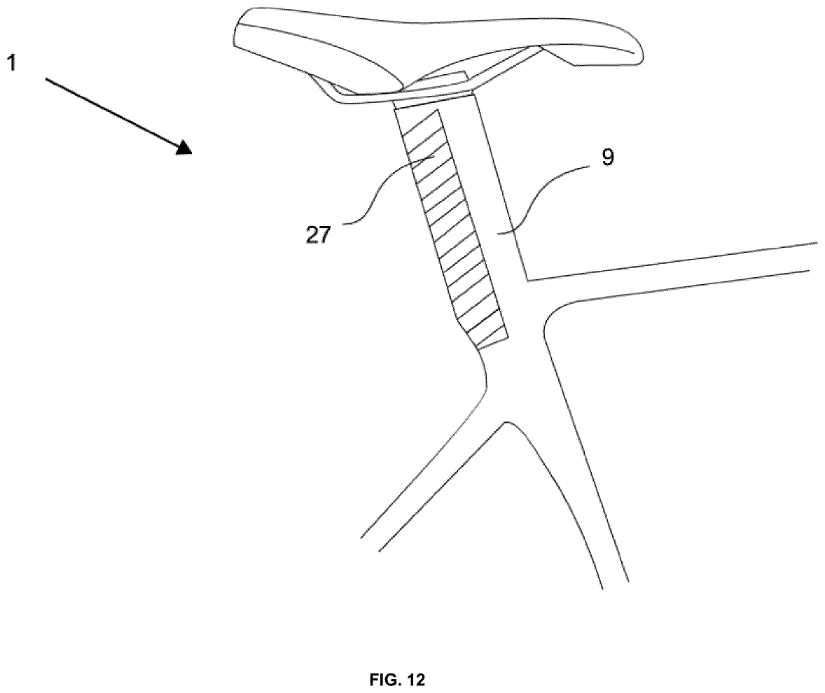

FIG. 12 depicts another non-limiting embodiment of a bicycle 1, where the trailing section 27 of the seat post 9 is the section of the frame element (being the seat post 9) which is moveable and/or morphable in shape. According to this non-limiting embodiment, seat post 9 is integrated with seat tube 14.

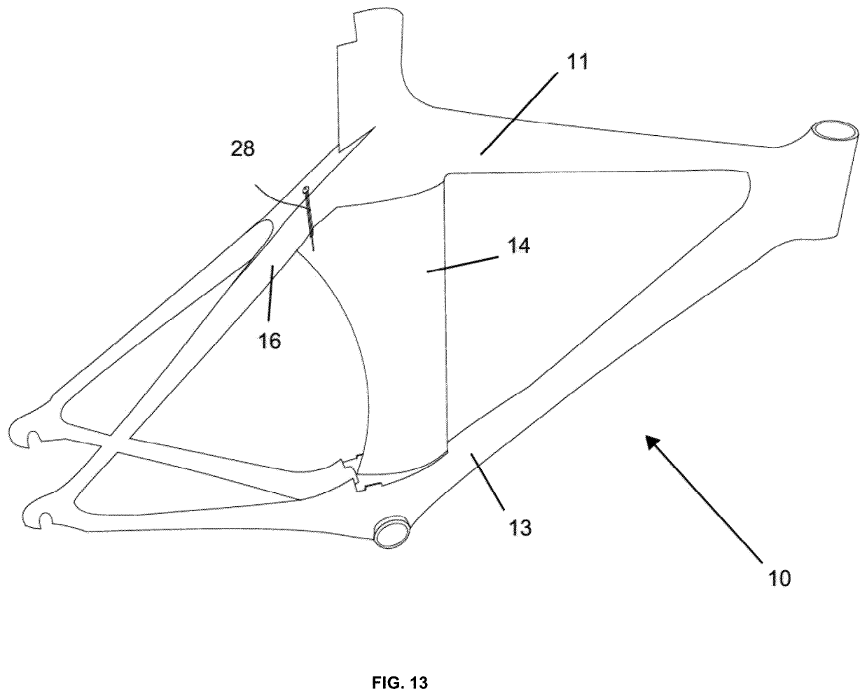

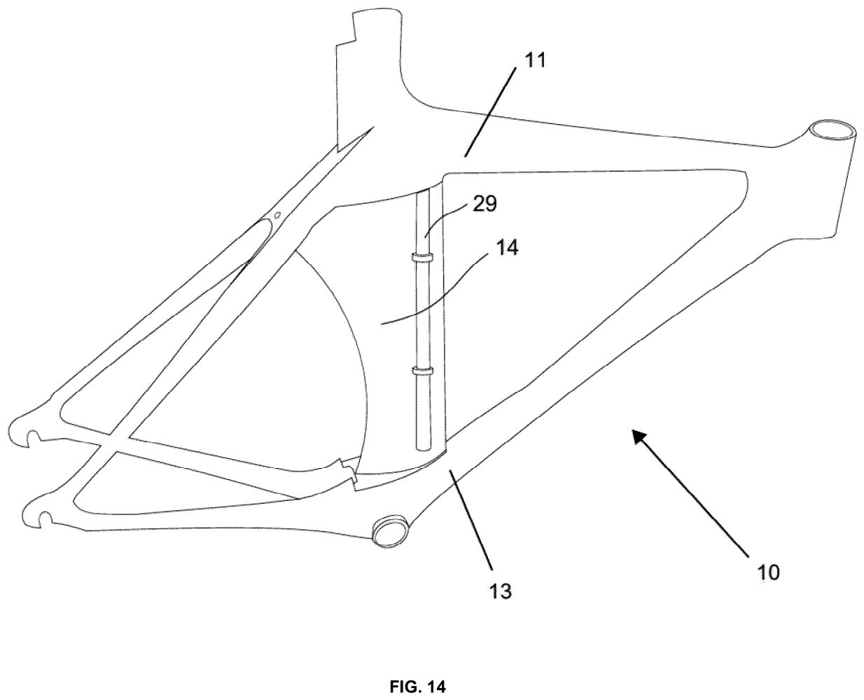

Various mechanisms may be used to enable the movement of the moveable and/or morphable frame elements of bicycle 1. Attention is now directed to FIGS. 13 and 14, which depict a bicycle frame 10 according to a non-limiting embodiment. According to this non-limiting embodiment, the moveable and/or morphable frame element is seat tube 14. According to this non-limiting embodiment, seat tube 14 is moveable when pin 28 (FIG. 13) is removed and dis-engaged. When pin 28 is removed the seat tube 14 moves by pivoting about shaft 29 (FIG. 14) contained within seat tube 14. According to certain non-limiting embodiments, shaft 29 (FIG. 14) is fixedly coupled to down tube 13 and top tube 11, while seat tube 14 is pivotally coupled to the down tube 13 and top tube 11, such that only seat tube 14 is capable of pivotal movement and both down tube 13 and top tube 11 are immoveable. According to further non-limiting embodiments, seat tube 14 may be fixedly coupled to shaft 29 (FIG. 14) and shaft 29 (FIG. 14) may be pivotally coupled to top tube 11 and down tube 13 such that rotation of shaft 29 (FIG. 14) about its longitudinal axis causes seat tube 14 to pivot about the longitudinal axis of shaft 29. According to some embodiments, if a lateral force, such as a cross-wind, is applied to pivotally moveable seat tube 14, the applied force will cause seat tube 14 to pivot relative to the rest of bicycle frame 10, and seat tube 14 may pivot to an orientation that minimizes the drag caused by the lateral force. Pin 28 (FIG. 13) may be inserted into a hole through the seat stays 16 and into a receiving hole of the seat tube 14 to thereby fix the position of seat tube 14 relative to the bicycle frame 10 to prevent any movement of the seat tube 10 even when subject to lateral forces, such as from cross-winds.

According to some embodiments, any moveable frame elements, portions thereof, or members of bicycle frame 10 may move when intentionally moved by an actuating mechanism, which may comprise any suitable electronic or mechanical mechanisms or other means known in the art which may be activated automatically or which may be activated by a user, to cause a movement (such as the rotation of the shaft 29 when the shaft is fixedly attached to seat tube 14 so that rotation of the shaft 29 causes pivoting of the seat tube about the longitudinal axis of the shaft 29). In this way, the seat tube 14, for example, can be intentionally moved to a preferred angle based on the prevailing wind conditions experienced by the cyclist, such as through a combination of inputs (e.g., mechanical dials) controllable by a user and electronically coupled to motors (e.g., servomotors), linkages and gears, as non-limiting examples. This permits the cyclist to adapt their bicycle frame 10 to the wind forces being experienced. This non-limiting embodiment can be applied to one or more frame elements of the bicycle 1.

The movement of the tubular elements may also be achieved by coupling a moveable frame element, or a moveable section of a frame element, to an immoveable frame element or other part of the bicycle 1 through a hinge joint, such as a flexible hinge joint, an expanding joint, a pivot joint or other suitable types of hinge and flexible joint variations known in the art. For example, according to some embodiments, the leading section of a frame element may be immoveable while the trailing section of the frame element may be movable and/or morphable. The leading section and the trailing section of a frame element may be coupled to each other by a hinge joint, such as a flexible hinge joint, which enables the movement of the trailing section of the frame element relative to the immoveable leading section of the frame element.

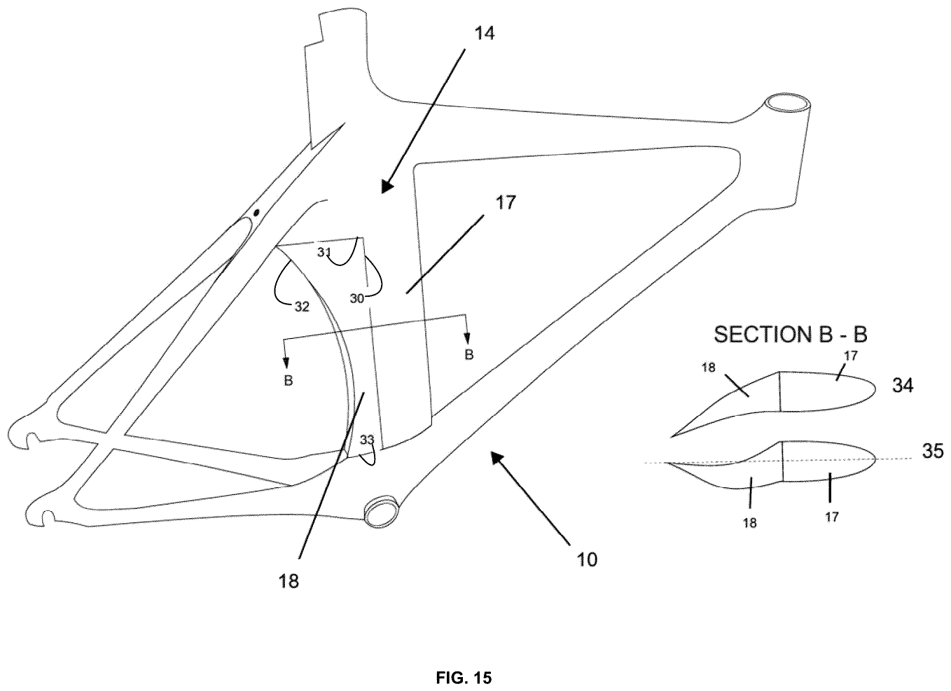

The frame elements of bicycle 1 may alternatively, or additionally, be moveable due to the nature of the material used in the construction of a given frame element or section of a given frame element, rather than, or not just by, the inclusion of a coupling mechanism such as a pivot or hinge joint. Attention is directed to FIG. 15 which depicts a bicycle frame 10 according to non-limiting embodiments, where the trailing section 18 of the seat tube 14 is capable of movement due to being comprised of flexible or deformable material. The leading section of the seat tube 17 remains fixed and immoveable as it is comprised of a rigid material.

In accordance with an example embodiment, Section B-B of FIG. 15 depicts two examples (34, 35) of the relative position of immoveable leading section 17 of seat tube 14 and the moveable trailing (via flexing or deformation) section 18 of the seat tube 14 when different external forces are applied to the trailing section 18. Various flexible materials known to those skilled in the art, such as rubbers, elastomer and various plastics and reinforced plastics can be used to comprise the flexible, moveable section of a frame element. Any suitable flexible material is contemplated.

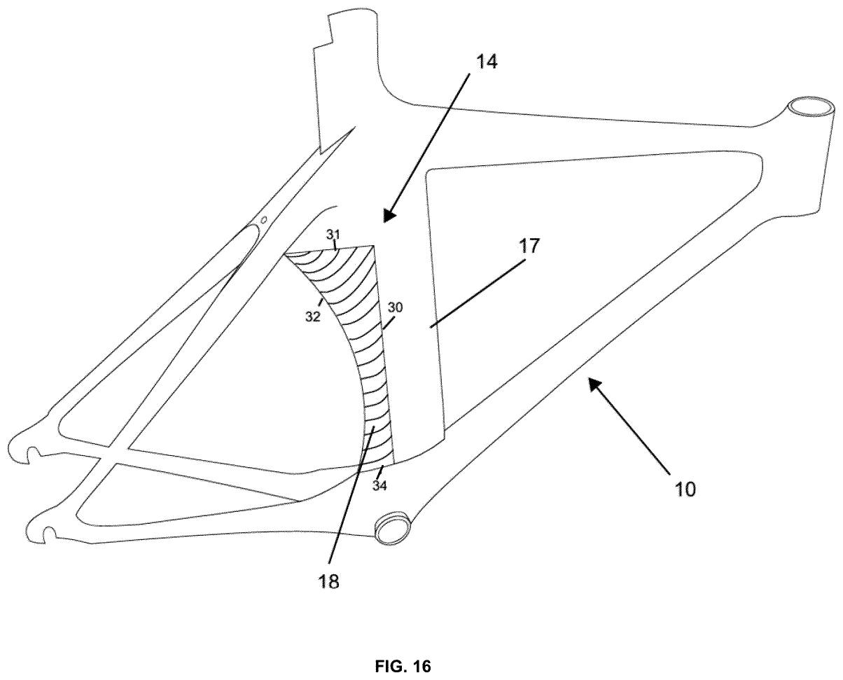

According to certain embodiments, the trailing edge 18 of seat tube 14 may be coupled by a varying number of connections. As depicted in FIG. 15 according to non-limiting embodiments, moveable trailing section 18 of seat tube 14 may only be coupled to the leading section 17 of seat tube 14 at side 30, while sides 31, 32 and 33 are not coupled to the remainder of seat tube 14. As depicted in FIG. 16 according to non-limiting embodiments, moveable trailing section 18 of seat tube 14 may be coupled to the leading section 17 of seat tube 14 at side 30, 31 and 34, while only side 32 is not coupled. According to non-limiting embodiments, various coupling means may be utilized including, but not limited to, hinge joints, pivot joints, expansion joints, flexible joints, condyloid joints, gliding joints, sliding joints, floating joints and other means known in the art, or any suitable combination thereof.

According to some embodiments, multiple sections of a frame element of bicycle 1 may be capable of independent movement and/or be capable of movement through different mechanisms.

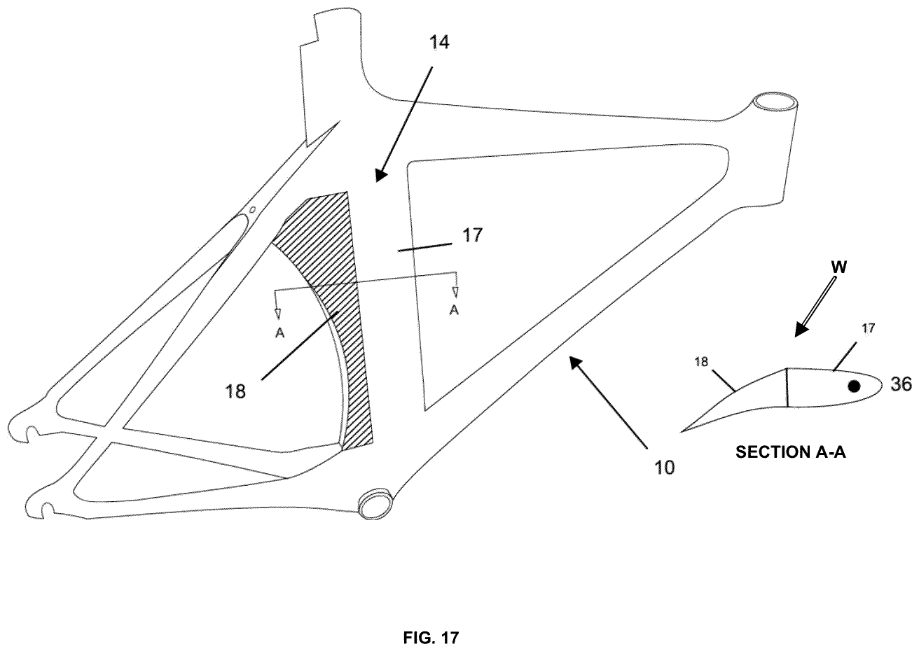

Attention is directed to FIG. 17, which depicts bicycle frame 10 according to a non-limiting embodiment, where leading section 17 of seat tube 14 and trailing section 18 of the seat tube 14 are both capable of movement and/or morphable, through different mechanisms. As depicted in FIG. 17, leading section 17 of seat tube 14 is moveable by a pivot mechanism (as described above and depicted in FIG. 13 and FIG. 14), while trailing edge 18 of seat tube 14 is moveable as trailing edge 18 is comprised of flexible material, also as described above and depicted in FIG. 16 and FIG. 17), according to non-limiting embodiments. Section A-A depicts the relative position 36 of moveable leading section 17 of the seat tube 14 and the moveable trailing section 18 of the seat tube 14 when acted upon by external lateral force(s), such as external wind force W, or actively repositioned by an actuating mechanism, according to non-limiting embodiments.

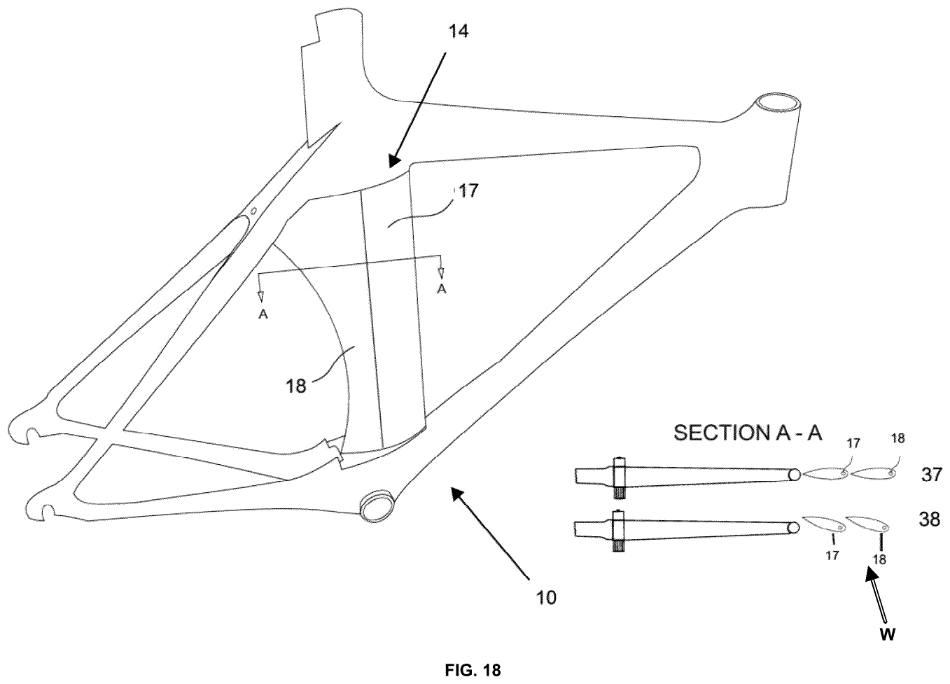

Attention is directed to FIG. 18 which depicts bicycle frame 10 according to a non-limiting embodiment, where leading section 17 of seat tube 14 and trailing section 18 of seat tube 14 are both capable of movement, independent from the other. Section A-A depicts the relative position of moveable leading section 17 of the seat tube 14 and the moveable trailing section 18 of the seat tube 14 when (i) in a neutral position 37 and (ii) when acted upon by external lateral force(s), such as external wind force W, or actively repositioned by an actuating mechanism 38, according to some embodiments.

Persons skilled in the art will appreciate that there are yet more alternative implementations and modifications possible, and that the above examples are only illustrations of one or more implementations. For example, while various example embodiments have been described above with respect to a seat tube, it will be appreciated that any such embodiments may apply to any other suitable frame elements or section(s) thereof of bicycle 1, bicycle frame 10 or any other suitable type of bicycle (such as a non-double triangle/diamond design). The scope, therefore, is only to be limited by the claims appended hereto.

### Interpretation

It will also be understood that for the purposes of this application, “at least one of X, Y, and Z” or “one or more of X, Y, and Z” language can be construed as X only, Y only, Z only, or any combination of two or more items X, Y, and Z (e.g., XYZ, XYY, YZ, ZZ).

In the present application, components may be described as being “configured to” or “enabled to” perform one or more functions. Generally, it is understood that a component that is configured to or enabled to perform a function is configured to or enabled to perform the function, or is suitable for performing the function, or is adapted to perform the function, or is operable to perform the function, or is otherwise capable of performing the function.

Additionally, components in the present application may be described as being “operatively connected to”, “operatively coupled to”, and the like, to other components. It is understood that such components are connected or coupled to each other in a manner to perform a certain function. It is also understood that “connections”, “coupling” and the like, as recited in the present application include direct and indirect connections between components.

References in the application to “one embodiment”, “an embodiment”, “an implementation”, “a variant”, etc., indicate that the embodiment, implementation or variant described may include a particular aspect, feature, structure, or characteristic, but not every embodiment, implementation or variant necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely”, “only”, and the like, in connection with the recitation of claim elements or use of a “negative” limitation. The terms “preferably”, “preferred”, “prefer”, “optionally”, “may”, and similar terms are used to indicate that an item, condition or step being referred to is an optional (not required) feature of the invention.

The singular forms “a”, “an”, and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A bicycle comprising:
one or more frame elements which are, in whole or in part, moveable and/or morphable in shape.

2. The bicycle of claim 1, wherein the one or more frame elements are moveable and/or morphable in response to an external force or a control mechanism operatively connected thereto.

3. The bicycle of claim 1, wherein the frame elements which are moveable and/or morphable comprise one or more of:
a front fork or one or more sections of the front fork;
a seat tube or one or more sections of the seat tube;
a cockpit or one or more sections of the cockpit;
a stem or one or more sections of the stem;
handlebars or one or more sections of the handlebars;
a seat tube or one or more sections of the seat tube;
a seat post or one or more sections of the seat post;
a top tube or one or more sections of the top tube;
a down tube or one or more sections of the down tube;
a head tube or one or more sections of the head tube;
a seat stay or one or more sections of the seat stay; and
a chain stay or one or more sections of the chain stay.

4. The bicycle of claim 1, wherein the moveable and/or morphable frame elements are moveable by actuation of an actuating mechanism operatively connected thereto.

5. The bicycle of claim 1, wherein the moveable and/or morphable frame elements are configured to move passively when subjected to an external force.

6. The bicycle of claim 5, wherein the external force comprises a lateral force.

7. The bicycle of claim 6, wherein the lateral force comprises a force from a cross-wind.

8. The bicycle of claim 5, wherein the external force comprises an aerodynamic wind load.

9. The bicycle of claim 1, wherein the one or more frame elements comprise one or more moveable frame elements or sections, wherein the moveable frame elements or sections are coupled to one or more immovable frame elements of the bicycle.

10. The bicycle of any one of claim 9, wherein at least one of the moveable and/or morphable frame elements are pivotably or hingedly coupled to one or more of the immovable frame elements or sections.

11. The bicycle of claim 1, wherein the moveable and/or morphable frame elements or sections comprise a flexible and/or a deformable material.

12. The bicycle of claim 1, wherein the moveable and/or morphable frame elements or sections move and/or morph by flexing and/or deforming when subjected to an external force.

13. The bicycle of claim 1, wherein the one or more frame elements comprise one or more moveable and/or morphable sections coupled to one or more immovable and/or non-morphing frame elements of the bicycle.

14. The bicycle of claim 13, wherein the one or more moveable and/or morphable sections are pivotably or hingedly coupled to at least one of the immovable and/or non-morphing frame elements.

15. The bicycle of claim 1, wherein the one or more moveable and/or morphable sections comprise a flexible and/or a deformable material.

16. The bicycle of claim 1, wherein the one or more moveable and/or morphable sections are configured to move and/or morph in shape by flexing and/or deforming when subjected to an external force.

17. A frame element for a bicycle comprising:
at least one section which is moveable and/or morphable in shape in response to one or more of an external force and actuation of a control mechanism operatively connected thereto.

18. The frame element of claim 17, wherein the at least one section is configured to move passively when subjected to the external force.

19. The frame element of claim 17, wherein the external force comprises an aerodynamic wind load.

20. The frame element of claim 17, wherein the at least one section is shaped as a fin or an airfoil trailing section.
